(19) United States
(12) Patent Application Publication
(10) Pub. No.: US 2010/0104757 A1
(43) Pub. Date: Apr. 29, 2010

(54) Surface Finishing System and Method

(76) Inventor: Nick Harmon, Albuquerque, NM (US)

Correspondence Address: PEACOCK MYERS, P.C., 201 THIRD STREET, N.W., SUITE 1340, ALBUQUERQUE, NM, 87102, US

(21) Appl. No.: 12/606,919

(22) Filed: Oct. 27, 2009

Related U.S. Application Data
(60) Provisional application No. 61/108,837, filed on Oct. 27, 2008.

(51) Int. Cl. B05D 5/00; C04B 14/00; B05D 1/38; B05D 1/28

(52) U.S. Cl. 427/257; 106/400; 427/270; 427/269; 427/260

(57) ABSTRACT

Embodiments of the present invention relate to a system and method for surface finishing, which allows for a surface to be painted and textured at the same time.

### CROSS-REFERENCE TO RELATED APPLICATIONS

This application claims priority to and the benefit of the filing of U.S. Provisional Patent Application Ser. No. 61/108,837 entitled “Surface Finishing Apparatus and Method”, filed on Oct. 27, 2008 and the specification thereof is incorporated herein by reference.

### BACKGROUND OF THE INVENTION

1. Field of the Invention (Technical Field)

Embodiments of the present invention relate to a system and method for surface finishing.

2. Related Art

Related art systems do not address the breadth of possibilities that the present invention does. With plaster and similar finishes, there is a time limitation or there is no consistency. Plaster has to be applied immediately after mixing, and can be limited in color selection. Other synthetic finishes do not have the natural consistency or look that can be obtained with the present invention. Additionally, related art finishes do not account for pre-existing abrasive textures without increasing cost of application.

Embodiments of the present invention cut down on waste and preferably create more efficiency during the finishing process. There is a need for a less expensive, more versatile surface finishing invention. The embodiments of the present invention fulfill that need.

### BRIEF SUMMARY OF THE INVENTION

Embodiments of the present invention relate to a surface finishing system having at least one custom-formulated pigment mix in combination with a joint compound, the combination forming at least one coat and a system of application of the combination on a surface.

Embodiments further comprise a mineral compound selected from the group consisting of interior stucco, clay, adhesive, and/or any combination thereof.

In the system, the at least one coat can include a base coat, a topcoat, a sealing coat, a finish coat and/or combinations thereof.

Embodiments of the method for surface finishing include providing a formulation by combining joint compound and a custom-formulated pigment mix; painting and texturing a surface simultaneously by applying at least one base coat, at least one top coat, at least one sealing coat and at least one finish coat to a surface; and applying the formulation and the coats to the surface, thereby creating an aesthetically pleasing appearance.

Surfaces include but are not limited to surfaces selected from the group consisting of canvas, glass, metal, plastic, fiberglass, tile, wood, adobe, drywall, rock, cement, brick, and substrate.

Embodiments of the method include applying a coat with a trowel and drywall pallet knives; applying a coat with a roller; and/or applying a coat with a sponge. One or more of the coats can include a varnish and/or an epoxy.

Finishing a surface optionally includes providing a clear surface, an opaque surface, a transparent surface, a translucent surface, a completely covered surface, a partially covered surface, a shiny surface, a flat surface, a semi-gloss surface, and/or any combination thereof.

Another embodiment of the method of painting a surface can include mixing one or more pigments into a joint compound and applying the pigmented joint compound to an existing wall surface.

Preferably, embodiments of the present method of applying the formulation and/or coats include but are not limited to applying an adhesive, a swirling technique, a cracking technique, a ridging technique, a layering velvety technique, a varnishing technique, a plastering Venetian technique, and abstracting a breakline between coats.

Objects, advantages and novel features, and further scope of applicability of the present invention will be set forth in part in the detailed description to follow, taken in conjunction with the accompanying drawings, and in part will become apparent to those skilled in the art upon examination of the following, or can be learned by practice of the invention. The objects and advantages of the invention can be realized and attained by means of the instrumentalities and combinations particularly pointed out in the appended claims.

### BRIEF DESCRIPTION OF THE SEVERAL VIEWS OF THE DRAWINGS

The accompanying drawings, FIGS. 1 through 4, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIGS. 1a-d are photographs illustrating embodiments of the present invention and application of the present invention to a surface;

FIG. 2 is a photograph illustrating a mixing compound of an embodiment of the present invention;

FIG. 3 is a photograph illustrating pigment of an embodiment of the present invention; and

FIG. 4 is a photograph illustrating applying an embodiment of the present invention to a ceiling.

### DETAILED DESCRIPTION OF THE INVENTION

Embodiments of the present invention relate to a system and method for surface finishing. An embodiment of the invention is a wall or other surface finishing technique comprising custom-formulated pigment mixes, a mineral based compound including but not limited to a joint compound, interior stucco, similar materials, combinations thereof, and sealer. Any appropriate surface can be finished with the present invention, in any shape, color, texture, or combination thereof. Application of the surface finish in one embodiment can be implemented using a trowel and drywall pallet knives. Embodiments of the present invention are applied to a surface that can optionally allow both painting and texturing the surface at the same time. The surface can then be sealed with a round-edge sponge or similar tool and a water-based acrylic varnish or similar material.

Embodiments of the present invention include but are not limited to preparation of a surface for finishing; application of a pigment; and an adhesive. One embodiment of the method of the present invention includes but is not limited to mixing colors and joint compound and/or similar material; applying a base coat; applying a top coat; and applying a sealer.

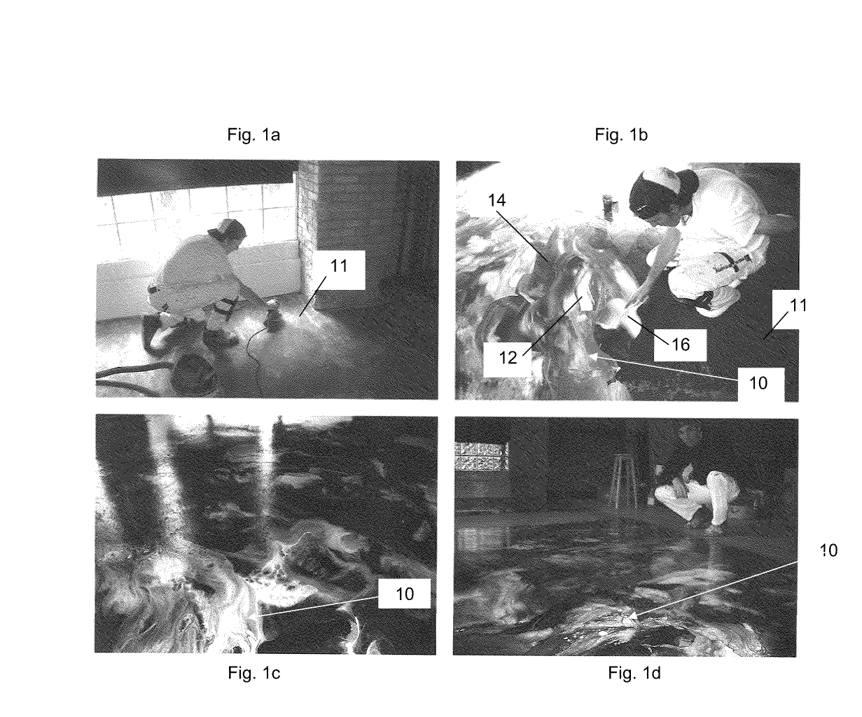

FIGS. 1a through d are photographs illustrating an application and method of an embodiment of the present invention. While this embodiment illustrates a floor application, the method can be used on virtually any surface. FIG. 1a shows floor 11 where the concrete is sanded with a heavy grit sand paper (e.g. 60 grit) or similar material. After sanding, the whole surface can be cleaned thoroughly. The floors can be sealed with a plurality of types of acrylic-like or similar sealer. After the seal dries and the temperature of the room cools to between approximately 60° F. to approximately 70° F., the next step can be application of an adhesive finish containing at least one pigment.

Alternative embodiments of the present invention can comprise the application to tiles and/or similar materials with a small surface (e.g. cement/fiber board), which materials are then applied to a larger surface.

### Floor Surface Embodiments:

in an embodiment of the present invention, surface finish 10, comprising adhesive 12 combined with pigment 14 is applied to floor 11 (FIG. 1). As illustrated in FIGS. 1 a, b, and c an adhesive can be applied in large drops preferably alternating various colors. The white pigment can be streaked throughout the section; more white pigment in a surface finish can be applied to create a busier appearance, and is applied as appropriate to a desired design. Variations of colors are preferably used to create different surface appearances.

Methods of application of embodiments of the present invention comprise pallet knife 16 (e.g. 14 inch) and/or similar implement can be used to spread the medium (FIG. 1b). After the finish is laid, it can be cured until it has completely dried. Air bubbles can occur that can be scraped and the entire surface vacuumed before the final sealer is applied. For a plurality of accent colors, shapes and designs, areas can be masked before application of the final sealer. There are substantially no design limitations.

### Application of the Sealer:

FIGS. 1c and 1d illustrate surface finish 10. Sealers can preferably use a paint roller and/or similar implement to create any desired texture (e.g. a fine nap). Once the surface is sealed, it preferably cures.

### Wall and Ceiling Surface Finish Embodiments:

The following describes alternative embodiments of the present invention. These embodiments can be used for virtually any surface and is preferably used for wall and ceiling surfaces. Embodiments of methods of the invention include but are not limited to preparation of walls and/or ceilings; mixing compounds with pigments; application of a base coat; application of a top coat; application of a sealer; application of a final topcoat; and/or any combination thereof.

Mixing the color with the joint compound and/or similar material preferably comprises transferring the pigments into a holder to draw the proper amount of the pigment. A variety of implements can be utilized including but not limited to syringes. To obtain the desired appearance, pigments can preferably be separated out. Next, the compound can be mixed in a bucket utilizing a power drill, a mixer and/or similar tools. The compound is preferably mixed to a creamy consistency by adding water. Once the proper consistency is achieved, the colored pigment is preferably added to the compound and mixed until the original color of the compound has disappeared. Several buckets can optionally be mixed at once. Mixing large batches can allow time savings and reduce pigment waste, because the compound does not need to be applied immediately, and can keep for long periods of time (e.g. several months).

The term “compound”, “mud” or “formulation” as used throughout this application is intended to include, but is not limited to a wet gypsum material applied to sheetrock joints, a synthetic-based formula used in combination with paper tape to conceal joints between drywall panels, any material that can be applied and adhere to a surface without immediately drying, a plaster-like substance used to fill seams and irregularities in drywalling, a vinyl-based drying material, a white substance similar to plaster used to seal joints between sheets of drywall, a liquid or semi-liquid mixture of water and some combination of soil, silt, and clay, a mixture of water and soil, a plaster-like mixture used to texture and/or smooth drywall, wet concrete as it is being mixed, delivered, and poured, colloidal suspensions of clays in fluid, fluid mixture of clay, chemicals, and weighting materials suspended in fresh water, salt water, or diesel oil, any material with particle size below ten microns in diameter, and/or any combination thereof. Certain areas can be masked for accented color, shapes and designs before the final sealer is applied. There are no design limitations using the present invention.

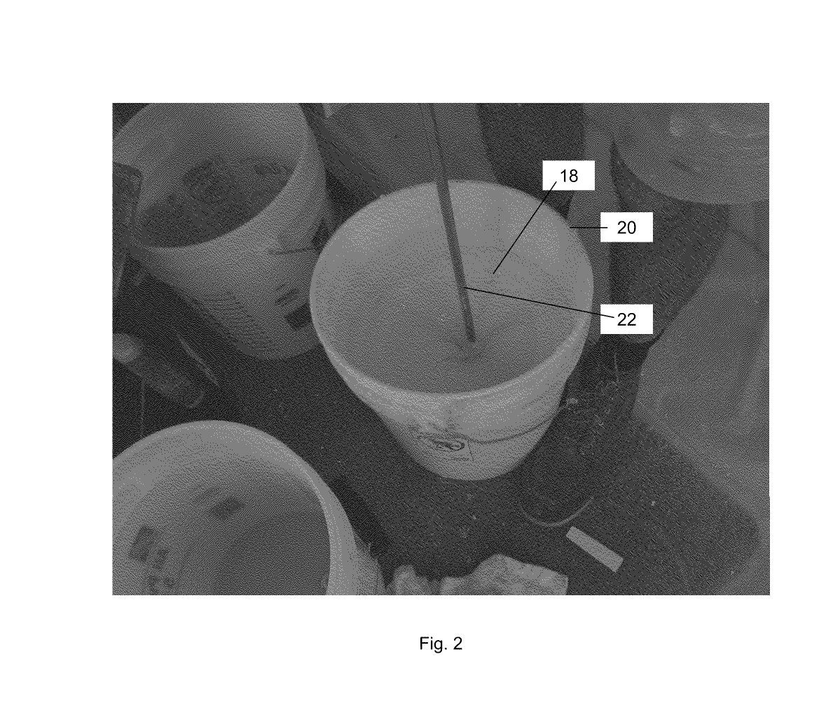

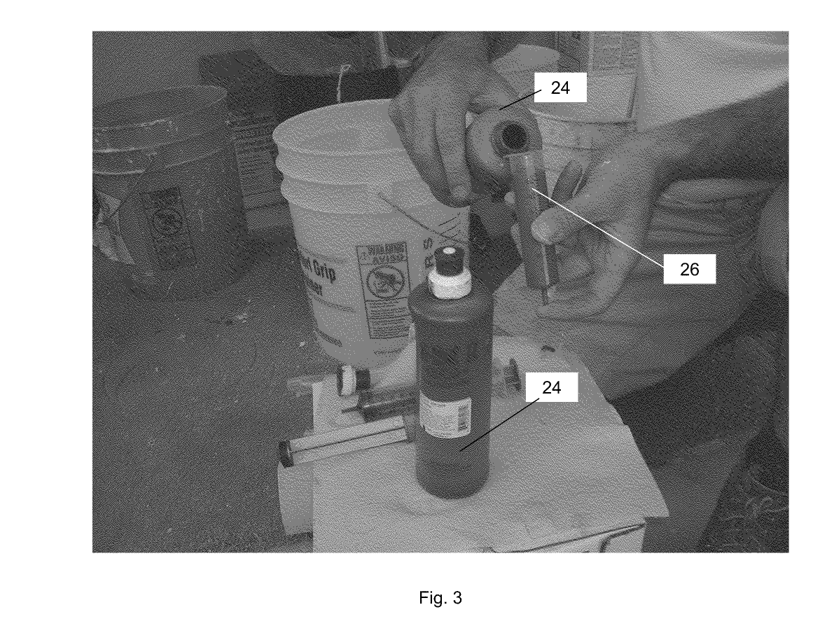

FIG. 2 illustrates a method of mixing a pigment into a compound to formulate an embodiment of the present invention. Unmixed compound 18 and/or similar material is placed into bucket 20 or another container for mixing. Mixer 22 can preferably be used to mix compound 18 in bucket 20 until a consistency appropriate for the surface. FIG. 3 illustrates pigment 24 poured into measuring and input tool (e.g. syringe) 26.

### Application of Base Coat:

Embodiments of the base coat can cover the existing texture and can preferably set the substrate for the topcoat of formulation. A plurality of tools can be used to apply the base coat, including but not limited to round-edged trowels or pool trowels, a pallet, a pallet knife, a variety of smaller plastic knives, and/or any combination thereof. Plastic knives can be cut and shaped into various sizes to access hard to reach spaces. A base coat can be applied with a roller, and in another embodiment the roller application can follow the trowel applicator. Alternately, the base coat can be applied by smoothing the base coat with a trowel while it is still moist. Consistency of the texture is preferable for the final appearance to cover large amounts of square footage without any break lines and/or color differences between batches of formulation.

### Application of Topcoats:

Application of a topcoat and/or the artistic coat can comprise substantially any design and/or texture. One embodiment of the topcoat includes but is not limited to swirling either two colors of joint compound together and/or various assortments of metallic pigments to achieve a one-of-a-kind look. The topcoat of the present invention preferably comprises a small amount of joint compound measured with a pallet knife onto a pallet, a small amount of metallic pigment, and swirling them together before the application. Different accent colors and swirling methods create different results. In an embodiment of the invention, to swirl two colors of formulation, for example, an approximately three-inch knife can be used to scoop the accent color and an approximately six inch knife can be used to scoop the dominant color. The two colors are then swirled on the pallet. The topcoat is preferably applied to a section of the wall surface and can be applied in any direction depending on the desired outcome.

Another embodiment of the topcoat application method is achieved by using similar colors and/or textures and working large abstract sections of a surface. One embodiment optionally creates an inconsistent break line and the formulation is pulled back off the wall, leaving a thin layer over the base coat. This embodiment creates a smoother, more velvety suede look.

An alternative application preferably comprises a pigmented adhesive rolled onto a surface and the formulation is preferably applied as the adhesive slowly dries. This combination creates a “cracking” effect as the glue dries more slowly than the formulation. The adhesive dries for between approximately 15 minutes and approximately 20 minutes before application of compound so that the compound will not slide and crack excessively. The time range varies as determined by the thickness of glue, the applicator's discretion, and the span of the surface.

Yet another embodiment employs a sand dune type of texture and can be created using a knife while building ridges up throughout a ceiling or wall. Textural lines, raised borders, etching and stenciling can also be created throughout the surface of the wall to create virtually any artistic design including but not limited to surface sculptures.

### Application of Sealer:

After any topcoat application, a sealer can be applied. One embodiment employs a water-based acrylic varnish. Any material with sealing or finishing properties can be used as a sealer. In this embodiment, a water-based varnish is used because an oil-based sealer can discolor the compound. The varnish is preferably applied with a round-edged sponge, and/or similar tool, and can be applied in any motion including but not limited to a circular motion. The corners and edges are preferably cut in with a brush-like tool allowing the acrylic varnish to seep into the formulation and create a sturdy surface for the final topcoat.

### Application of Final Topcoat:

An alternative embodiment uses a medium with a thick, yoghurt-like consistency and can be applied using a trowel. In an embodiment that employs a final topcoat, one alternative is to cover the surface and then scrape it back, leaving only the remaining portion attached to the surface. In this embodiment, as well as other embodiments that comprise at least two coats, a large scoop of the formulation is spread on a surface, preferably on an approximately 3 feet by 3 feet section. Then, a joint compound implement including but not limited to a trowel, held at an approximately 45 degree angle, is preferably used to scrape in a motion back from the original application of joint compound. The scraping pulls off joint compound, but the pressure applied is not enough to scratch the under layer and/or the surface underneath. Variations on sheens are adjusted by adding different materials and pigments, and by utilizing a plurality of application techniques known in the industry.

### Finished Surfaces:

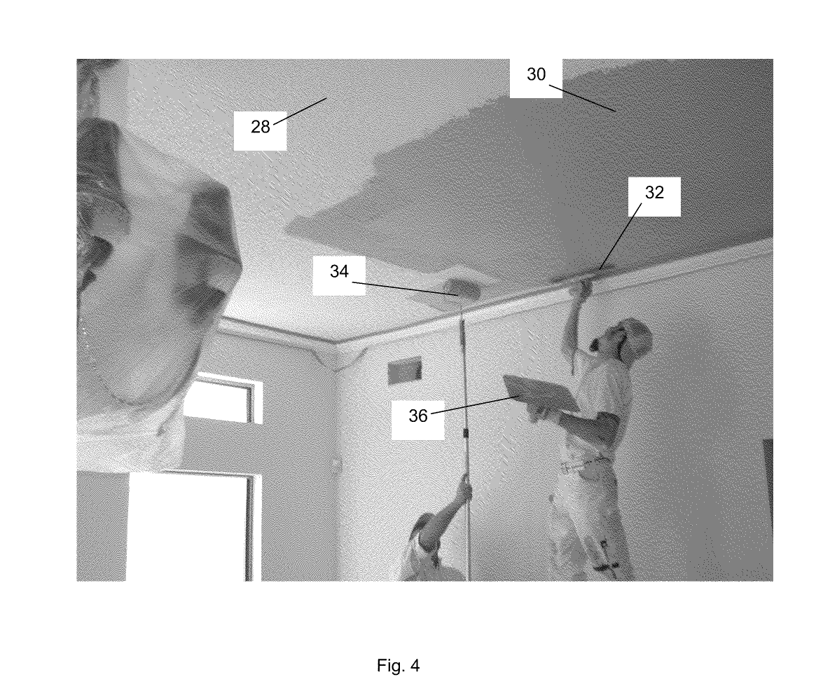

FIG. 4 illustrates an embodiment of the finish being applied to ceiling surface 28. Finish 30 can be applied using trowel 32 or similar implement, and/or paint roller 34 and pallet 36. Textures can be changed by using any variety of tools, including but not limited to roller heads.

Alternative embodiments comprise applying finish with a trowel and pallet to taped and/or textured or untextured sheetrock. For example, one can apply the finish to sheetrock finished to a level three, or taped and coated but not textured. Another embodiment of the present invention includes but is not limited to application to a wall surface.

Alternative embodiments of the present invention are finishes for a plurality of surfaces including but not limited to canvas, glass, metal, plastic, fiberglass, tiles, wood, brick, and other substrates. Alternative embodiments can be surfaces used for entire walls or floors, portions of walls and floors, and/or as completely decorative (e.g. decorative hanging and/or surface sculpture).

Embodiments of the present invention can use substantially any color to create custom designs. When each custom formulated pigment is mixed into the joint compound, the final product is an original.

### Alternative Embodiments and Other Surface Finishes:

Embodiments of the invention include but are not limited to using adhesives comprising a white pigment ratio of approximately 6 cc pigment per approximately 24 ounces of adhesive. The base mixture is alternatively blended with other pigmented adhesives. The surface can be sealed with an acrylic epoxy, for example a two-part acrylic epoxy and/or similar material. The sealer can be optionally applied on top of the pigmented adhesive and the clear epoxy allows for brighter, higher definitions of color. The final product is preferably a durable archival work of art.

Alternative embodiments include a transparent embodiment. This embodiment is managed by the ratios of glue and pigment used. The transparency and clarity of the finish is greater or lesser depending on differing mixtures of glue and pigment. This embodiment results in a finish that is used on any appropriate item, including but not limited to glass tabletops, glass blocks, backlit signs, custom fit window coverings, custom cut acrylic and plastic, and custom recycled window panes.

The invention is further described in the documents attached hereto. While one embodiment of the invention is directed to finishes, the invention is also useful for any surface application.

### INDUSTRIAL APPLICABILITY

The invention is further illustrated by the following non-limiting examples.

### Example 1

### Mixing Colors and Joint Compound

The color was mixed with the joint compound (mud). Mixing began by transferring the pigments called CAL-TINT® (Evonik Dgussa Corporation) from the bottle into a disposable cup. 35 cc needleless syringes were used for transferring the pigment. Each pigment was transferred into its own cup. Pigments were not mixed together before they went into the mud. One box of sheet-rock all-purpose joint compound, commonly found at home improvement stores, was mixed in a 5-gallon bucket with a high power drill having a mixer attachment. The mud was mixed to a creamy consistency by steadily adding water. Once the proper consistency was achieved, the colored pigment was added to the mud and whipped until the white disappeared. Several buckets were prepared and mixed at once, which saved time and minimized waste.

The joint compound (mud) was lightweight and all-purpose. To do a patch or a fill, the glue that is found in the all-purpose mud is good for patching and adhering the finish to painted tiles, wood, brick, and other substrates.

With respect to custom-designed colors, care must be taken to maintain the consistency of specialized formulas. One formula of substantially any variation comprising a color formula for a pigment that was used was:

20 cc Raw Umber
20 cc Burnt Umber
20 cc Raw Sienna

Hundreds of different pigment combinations can be created using different formulas. Each pigment was mixed into the mud, producing an original creation tailored to the desired taste and design.

### Applying the Base Coat:

The base coat covered the existing texture and set the substrate for the topcoat of mud. A 14″ round-edged trowel, a 12″ pallet, a 6-inch pallet knife, and various assortments of smaller plastic knives were used. The plastic knives were cut and shaped into various sizes that allowed access to hard-to-reach spaces. The base coat was then rolled out with a roller and followed as the applicator. The base coat was applied, smoothing the base coat out with a pool trowel while it was still moist. This abstract consistency of the “lightening bolt texture” was important to the final appearance. The “lightening bold texture” is a subtle texture to make a surface appear to be stone. Preferably a round trowel and/or similar instrument is utilized. The base coat is preferably applied with high and low areas, and/or built up areas and non-built up areas. This embodiment allows the texture to gather and/or concentrate color from the second coat. The second coat is preferably applied, in this embodiment, without texture and is preferably to create different color concentrations. Large amounts of square footage were achieved without any break lines or color differences from one batch of mud to the next.

### Applying the Topcoat:

The versatility of the topcoat, also referred to as the artistic coat, allowed designs that ranged from a raised Aspen tree to subtle layers of smooth coats. The four techniques or coats (described below) used most commonly were “The Swirl”, “The Layered Method”, “Rare Earth”, and “Artistic Finishes”.

### “The Swirl”

This method is unique to joint compound. Because of the soft consistency of the medium, two colors of joint compound can be swirled together or various assortments of metallic to achieve a one-of-a-kind look. This was done by using one scoop of mud with the six-inch knife on the pallet, a small pancake-sized amount of metallic, and swirling them together before the application. Use of two colors of mud required a three-inch knife to scoop the accent color and a six inch knife to scoop the dominant color, which were then quickly swirled on a pallet. Over-mixing was avoided to prevent the mediums from blending too much and losing the desired effect. The swirled mixture was then applied to a 3′×3′ section of the wall surface, starting in the upper left hand corner and worked from left to right across the surface. For left handed applications, one would start in the upper right hand corner and work right to left or counter clockwise.

### “The Layered Method”

This method was achieved by using relatively the same or different color, applying it to 3′×3′ sections of the wall and working large abstract sections of the wall. This created an inconsistent break line. The mud was then pulled back off the wall in a similar technique to those described above, leaving a thin layer over the base coat. This created a smoother, more velvety suede look.

“Rare Earth”

This finish was more time consuming, however highly artistic. In this application, pigmented ELMER'S® Glue (Elmer's Products, Inc.) was used, rolling it over the wall surface with a paint roller. The joint compound was then applied as the glue slowly dried. This combination created a “cracking” effect as the glue dried more slowly than the mud. Fifteen minutes passed between the application of the glue and the mud, so that the mud would not slide and crack excessively.

“Artistic Finish”

This was a sand dune type of texture and was created using an 8-inch knife while building ridges up throughout a ceiling or wall. Textural lines can also be created throughout the surface of the wall, as well. Raised borders, etching and stenciling can be achieved with the workability of the mud. If something like raised Aspen trees or bamboo shoots applied decoratively to the wall is desired, this process allows that look to be created.

Applying the Sealers—WOOD PRIDE® water-Based Acrylic Varnish and The Venetian Topcoat:

“Wood Pride™ Water-Based Acrylic Varnish”

After one of the four topcoats was applied, the sealer was applied. The first step was to apply the WOOD PRIDE®, (The Glidden Company) a water-based acrylic varnish. Water-based varnish was used instead of oil-based, because oil discolors the mud. The varnish was applied with a round-edged sponge in a circular motion. This medium has a thick but runny consistency, which is why it was sponged on. Once again, it is important to keep the swirl pattern inconsistent as the sealer was moved left to right across the wall. All corners and edges were cut in with a two-inch brush during movement. The acrylic varnish then seeped into the mud and created a sturdy surface for the Venetian Topcoat to adhere to. After the water-based varnish was finished, the wall sheen had a cloudy appearance. The surface was then ready for the final coat, the Venetian Topcoat.

“The Venetian Topcoat”

MODERN MASTERS™ Venetian Topcoat (Modern Masters Inc.) was used for the final coat. This medium has a thick, yoghurt-like consistency and was troweled on using the same 14-inch pool trowel used with the mud. Covering only the surface, the topcoat was troweled on, then removed, leaving only a thin layer on the wall. A metallic sheen was achieved in this coat by adding a ration of 1 cc of metallic per 1 ounce of Venetian Topcoat. A stronger or lesser metallic sheen was achieved by adding more or less metallic to the ratio. A ratio of pigment was added to the Venetian Topcoat to tint it, changing the overall tone of the surface.

For the finish technology, pigmented ELMER'S® Glue was used in the joint compound mixture for the wall surfaces. This medium has broad decorative and artistic qualities. Various pigment ratios were used in the glue, mixing blues, greens, yellows and various colors together. What occurred were beautiful, colorfully abstract designs as the glue dried. Different chemicals and other color combinations were used. Blending a white pigment with the glue and then adding that mixture to the colored glue gave a cleaner look for art pieces. The medium was sealed with a two-part fiberglass resin or a two-part clear epoxy. Using the epoxy allowed for a brighter finish, a higher definition of the colors, and a cleaner, clearer presentation of the art pieces.

A white pigment ratio of 6 cc pigment per 24 ounces of ELMER'S® Glue was used. That mixture was blended with the other pigmented ELMER'S® Glue colors. It was then applied to sheet rock and framed with a “J Metal” frame technique. The front was sealed with a two-part acrylic epoxy. When applied to the top of the pigmented ELMER'S® Glue, the clear epoxy allowed for brighter, higher definitions of color from the pieces, giving each piece its unique effect. The backs were then named, signed, dated and sealed with the same water based acrylic varnish. The final product was an extremely durable archival work of art.

### Transparency:

Another aspect of the invention is its transparency and clarity, managed by the ratios of glue and pigment used. If the glue is saturated too much by the pigment, the surface can lose its transparent quality. Therefore, those ratios can be cut in halves and quarters. This allows one to create as much transparency as desired. The result is a look that reflects a design stronger than what can be found in stained-glass art pieces. This finish can be used on glass tabletops, glass blocks, backlight signs, custom fit window coverings, custom cut acrylic and plastic, custom recycled two pane windows, and much more.

### Floors

### Preparing the Floors for Finish:

In preparing floors for the finish, the concrete must first be sanded with a coarse grit sand paper (e.g. 60 grit). After sanding, the whole surface is cleaned thoroughly. The floors then are sealed (e.g. with some type of acrylic). Wood Pride™ acrylic varnish is sufficient for this. After the acrylic dries and the temperature of the room cooled (e.g. to 60 degrees), the glue finish is applied, which then is sealed with another final layer of an industrial floor sealer.

### Application of the Pigment and the Glue:

There are several ways to apply the glue. Large pancake-sized drops of the various colors were laid out in an alternating fashion. The white pigment was then streamed throughout the section. White is useful for creating a busier look in the pieces, but not necessary for each piece. Using variations of relative colors can attain a more subdued look. Starting with a 4′×4′ section and working from one corner of the room to a projected finishing point provided the best result, preventing interference with what was already laid. Equally, keeping the break line abstract was useful for achieving consistency with the look. A 14-inch pallet knife was used to achieve the spreading of the medium, taking care not to spread the medium too thinly. The colors blended over and created an undesirable effect. After the glue was laid, it was cured for two days. Air bubbles infrequently occurred, which were scraped with caution and the entire surface then vacuumed with a vacuum and brush attachment before the final sealer was applied.

### Application of the Sealer:

One sealer used in this example was organic, water-based brand COROPDXY® (Coronado Paint Company, Inc) and it is considered to be environmentally friendly. This sealer was used on a floor and has held up under foot traffic for at least six months. Another sealer used was SUPERTHANE REZ® (Pittsburgh Plate Glass Company Corporation), which is a more substantial industrial sealer. SUPERTHANE REZ® is suited for use on exterior surfaces and high-traffic areas. Of the two sealers noted, COROPDXY® appeared to provide less durable results than SUPERTHANE REZ®. However, a second coat can be applied within 48 hours to ensure maximum durability. Both sealers were applied using a paint roller and a fine nap roller attachment. Once the floor was sealed, it was allowed to cure for at least seven days to increase durability. One excellent aspect of this finish was that it was a coating and not a stain. The coverage was substantial enough that none to little preparation was required for concrete substrates.

### Application on “Tiles”

The glue finish was applied to precut pieces of moisture resistant wet board. The pieces were sealed using the floor seal process. The sheets of the raw material were 3′×5′ moisture resistant board that contractors can use in between the stud and the tile of newly constructed walls. In another application the tile was cut and the finish was applied directly to the backing board. In yet another application, this technique was employed but, instead of cutting individual tiles and placing them together, the tiles were cut as templates to fit in a shower.

The preceding examples can be repeated with similar success by substituting the generically or specifically described operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

What is claimed is:

1. A surface finishing system comprising:
at least one custom-formulated pigment mix in combination with a joint compound forming at least one coat; and
a system of application of said combination on a surface.

2. The finishing system of claim 1 wherein the joint compound further comprises a mineral compound selected from the group consisting of interior stucco, clay, adhesive, and a combination thereof.

3. The system of claim 1 wherein the at least one coat comprises a coat selected from the list consisting of a base coat, a topcoat, a sealing coat, a finish coat, and a combination thereof.

4. A method for surface finishing comprising:
providing a formulation by combining joint compound and a custom-formulated pigment mix;
painting and texturing a surface simultaneously by applying at least one base coat, at least one top coat, at least one sealing coat and at least one finish coat to a surface; and
applying the formulation and the coats to the surface, thereby creating an aesthetically pleasing appearance.

5. The method of claim 4 wherein the surface comprises a surface selected from the group consisting of canvas, glass, metal, plastic, fiberglass, tile, wood, adobe, drywall, rock, cement, brick, and substrate.

6. The method of claim 4 wherein applying a coat comprises applying a coat with a trowel and drywall pallet knives.

7. The method of claim 4 wherein applying a coat comprises applying a coat with a roller.

8. The method of claim 4 wherein applying a coat comprises applying a coat with a sponge.

9. The method of claim 4 wherein at least one of the coats wherein a coat comprises a varnish.

10. The method of claim 4 wherein a coat comprises an epoxy.

11. The method of claim 4 wherein the system of finishing a surface comprises a finished surface selected from the group consisting of a clear surface, opaque surface, transparent surface, translucent surface, a completely covered surface, a partially covered surface, a shiny surface, a flat surface, a semi-gloss surface, and a combination thereof.

12. The method of claim 4 wherein the system of painting a surface comprises mixing one or more pigments into a joint compound and applying the pigmented joint compound to an existing wall surface.

13. The method of claim 4 wherein applying the coats comprises applying an adhesive.

14. The method of claim 4 wherein applying the formulation and the coats comprises applying with a swirling technique.

15. The method of claim 4 wherein applying the formulation and the coats comprises applying with a cracking technique.

16. The method of claim 4 wherein applying the formulation and the coats comprises applying with a ridging technique.

17. The method of claim 4 wherein applying the formulation and the coats comprises applying with a layering velvety technique.

18. The method of claim 4 wherein applying the formulation and the coats comprises applying with a varnishing technique.

19. The method of claim 4 wherein applying the formulation and the coats comprises applying with a plastering Venetian technique.

20. The method of claim 4 wherein applying the formulation and the coats comprises applying to abstract a breakline between coats.
